(19) United States
(12) Patent Application Publication
(10) Pub. No.: US 2006/0011290 A1
(43) Pub. Date: Jan. 19, 2006

(54) Method and device for fabricating a hollow body containing at least one insert

(76) Inventor: Manfred Geiss, Sesslach (DE)

Correspondence Address: MOORE & VAN ALLEN PLLC, P.O. BOX 13706, Research Triangle Park, NC, 27709, US

(21) Appl. No.: 11/183,932

(22) Filed: Jul. 18, 2005

(30) Foreign Application Priority Data
Jul. 19, 2004 (DE) 10 2004 034 906.1

(51) Int. Cl. B29C 65/00; B32B 37/00

(52) U.S. Cl. 156/245; 156/381

(57) ABSTRACT

For fabricating a hollow body 40 containing at least one insert 33 from two thermoplastic blanks 11, 12 by means of vacuum forming or thermoforming the thermoplastic blanks 11, 12 are fed into one single closable machine housing and are separately and simultaneously formed to formed parts in the machine housing, whereafter at least one insert 33 in inserted into a formed part 12′ and fixed in the same, the formed parts are joined and bonded in a pressing contact, whereafter the finished hollow body 40 with the integrated insert 33 is withdrawn upon opening the machine housing. To this end, the device 10 comprises two forming stations 14 and 15 with respective devices for moving the form tool 30, 31, for clamping and heating a thermoplastic blank and for arranging and affixing the at least one insert 33 in a formed part 12′, wherein the formed part 12′ with the insert 33 affixed therein can be moved by the mover 32 of the associated form tool 31 to contact the other formed part 11′ and to bond it therewith.

The invention relates to a method for fabricating a hollow body containing at least one insert from two thermoplastic blanks by means of vacuum forming or thermoforming, and to a corresponding device.

A specific method for fabricating hollow bodies from two thermoplastic blanks by means of vacuum forming or thermoforming, also called twin sheet method, has already been known. Two thermoplastic blanks are thereby heated, vacuum-formed and subsequently bonded with their inherent heat to form a hollow body. This method is typically performed on a one-station machine, wherein two thermoplastic blanks mounted above the other are heated and processed. However, this method has the drawback that no additional components or inserts may be placed in the interior of the hollow body because said two thermoplastic blanks have to be detained airtight at a defined pitch by means of a holding system so as to prevent an uncontrolled sagging of the individual thermoplastic blanks.

For allowing additional components or inserts to be placed in the interior of the formed parts it would also be conceivable to apply the so-called twin sheet method in multistation machines, wherein the formed parts are fabricated successively and are completed with inserted inserts prior to their assembly. It is a drawback, however, that in such multistation machines the heated thermoplastic blanks are at first heated in a heating station and are then moved through standing air into the subsequently arranged forming station, wherein the sagging of the thermoplastic blanks cannot be controlled and influenced. In addition, also the expenditure of time for the fabrication of such formed parts is considerable, as both formed parts are formed successively.

The invention is accordingly based on the object to provide a method and a device of the aforementioned kind, by means of which the hollow bodies comprising at least one integrated insert can be fabricated fast and in a highly qualitative manner.

According to the invention this object is provided by the features relating to a method mentioned in patent claim 1 and by the features relating to a device mentioned in patent claim 9.

Preferred additional embodiments of the method are described in the dependent patent claims 2 to 8, while preferred additional embodiments of the device are mentioned in claims 10 to 13.

According to the inventive embodiment of the method and the device hollow bodies can be fabricated from a thermoplastic material with at least one insert in a reliable, highly qualitative and fast manner. To this end, both formed parts are continuously and simultaneously fabricated in a single closed medium and, with the insertion of at least one insert, are bonded securely and reliably. The closable machine housing is opened merely for feeding the thermoplastic blanks and for withdrawing the finished hollow body comprising the at least one integrated insert, wherein both thermoplastic blanks for the upper formed part and for the lower formed part are preferably fed at the same time, while the feeding of the thermoplastic blanks and the withdrawal of the finished hollow body are preferably performed isochronously.

Both forming stations provided in the closable machine housing have in principle the same structure, wherein one forming station comprises a form tool for an upper formed part and the other forming station comprises a form tool for the lower formed part, and wherein a clamping frame associated with the respective tool halves and preferably a continuously adjustable single-plate system for the opposing edge sides of the thermoplastic blank are provided for the vacuum forming or thermoforming.

For joining the formed parts it is advantageously provided that one formed part is released from the clamped position in the one forming station and is moved, together with the form tool, to the other formed part still being in its clamped position in the forming station.

In each forming station the respective thermoplastic blanks are preferably heated on both sides prior to the forming by means of heaters, wherein the heaters are moved from their working position into an inoperative position outside the area of the form tools after the forming. By this, an extremely compact realization of the device with short movement paths for the formed parts and the finished hollow part is obtained.

The clamping frame provided for each forming station can preferably be moved away from all edges of the thermoplastic blank as to release the formed part, and each forming station moreover advantageously comprises a continuously adjustable window plate system which can preferably intermittently be driven apart to arrange the thermoplastic blank on the clamping frame.

For the sequence of the movements provided inside the device a mover is preferably provided for the lower formed part with the insert located therein, for the lowering and lifting in the area of the forming station appertaining to said formed part, as well as for a lateral shifting to the other forming station and for the lifting and lowering in the area of the other forming station.

According to another preferred embodiment of the device the forming station, in which both formed parts are bonded, comprises grip elements for removing the hollow body from the advanced form tool, which are movable under the clamping edge of the upper half of the formed part and which can be lifted together with the upper form tool and moved apart for the withdrawal of the hollow body to release the same after opening the associated clamping frame. This realizes an extremely simple, effective and reliable handling of the hollow body inside the closed machine housing.

According to another embodiment of the invention the machine housing comprises at least one closable opening for feeding thermoplastic blanks and for withdrawing fabricated hollow bodies, through which preferably a charge carriage is provided for the simultaneous feeding of both thermoplastic blanks, preferably at the lower side thereof, and for the withdrawal of the hollow body, preferably at the upper side thereof. This advantageously realizes a handling with one single handling member which continuously allows an isochronous feeding and withdrawal.

According to another embodiment of the invention each forming station comprises a heater for the surface of the thermoplastic blank and a heater for the lower side of the thermoplastic blank, wherein each heater can be moved from a working position into an inoperative position outside the area of the form tools.

According to another embodiment of the invention it is additionally provided that the thermoplastic blanks for the fabrication of the halves of the formed parts are differently sized, wherein the lower formed part, in which the at least one insert is arranged, has a comparatively smaller edge than the upper formed part so as to form a grip edge for the grip elements at the edge of the upper formed part.

Further details, features and advantages of the invention can be inferred from the following description, in which an embodiment of the invention will be explained in more detail with reference to the attached drawings.

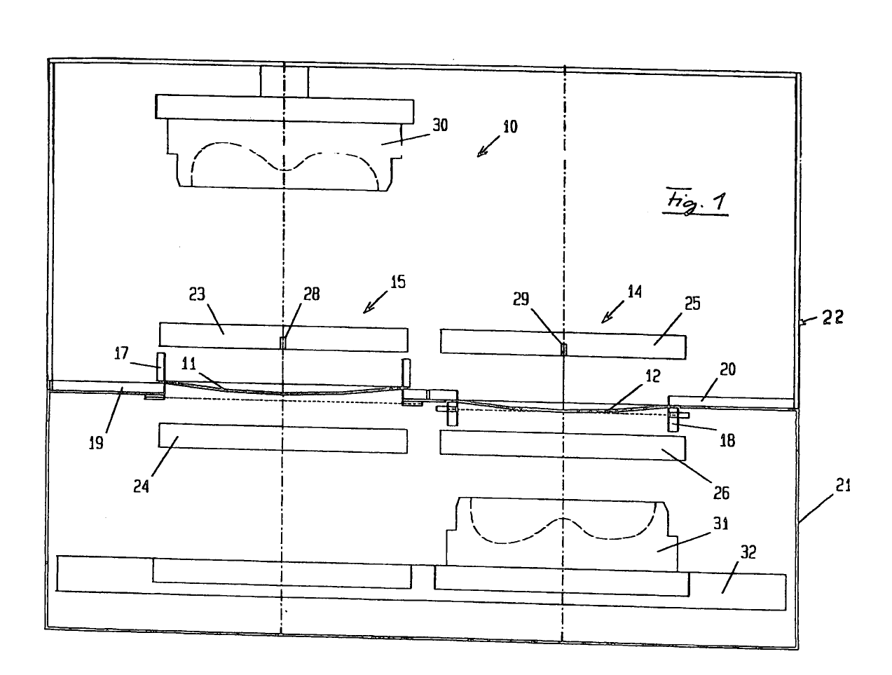

FIG. 1 shows a schematic representation of an embodiment of a device according to the invention in a position, in which both forming stations are already charged with a thermoplastic blank;

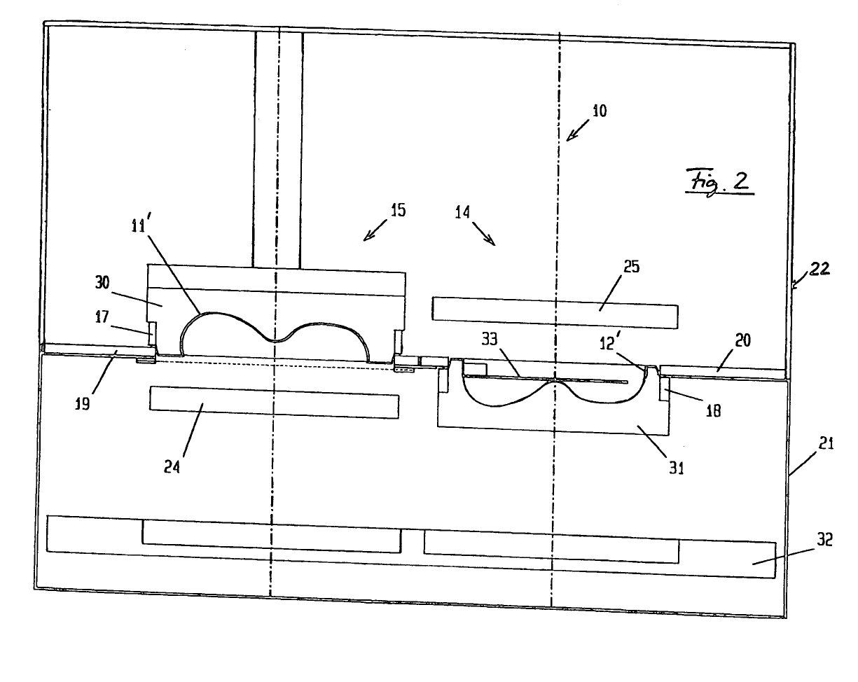

FIG. 2 shows a schematic representation of the device according to FIG. 1, wherein both thermoplastic blanks are already simultaneously formed and wherein an insert is inserted into the right formed part;

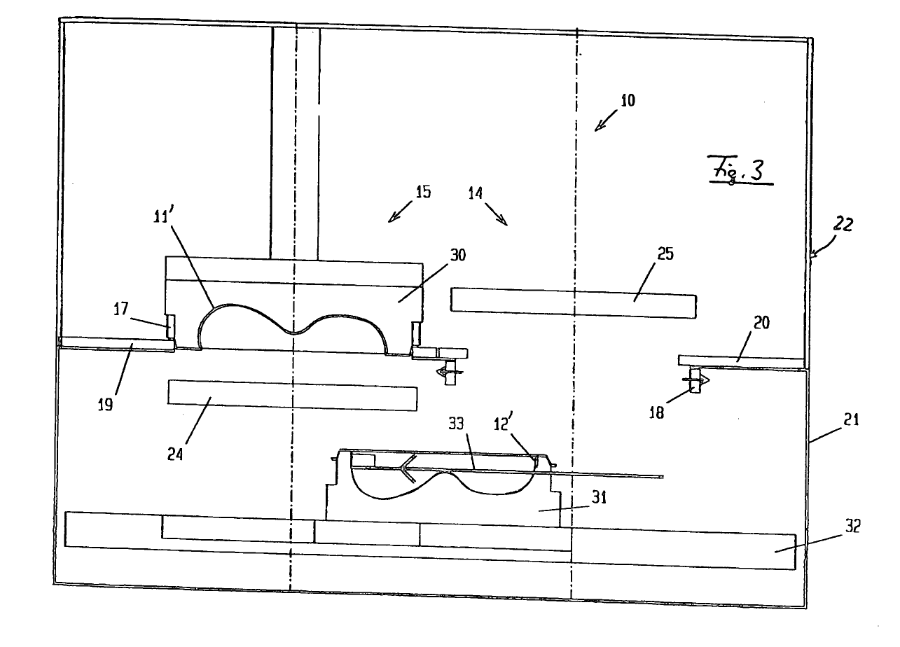

FIG. 3 shows a schematic representation of the device according to FIG. 1 in a phase, in which the lower formed part with the insert affixed thereto moves from the right forming station to the left forming station after the release;

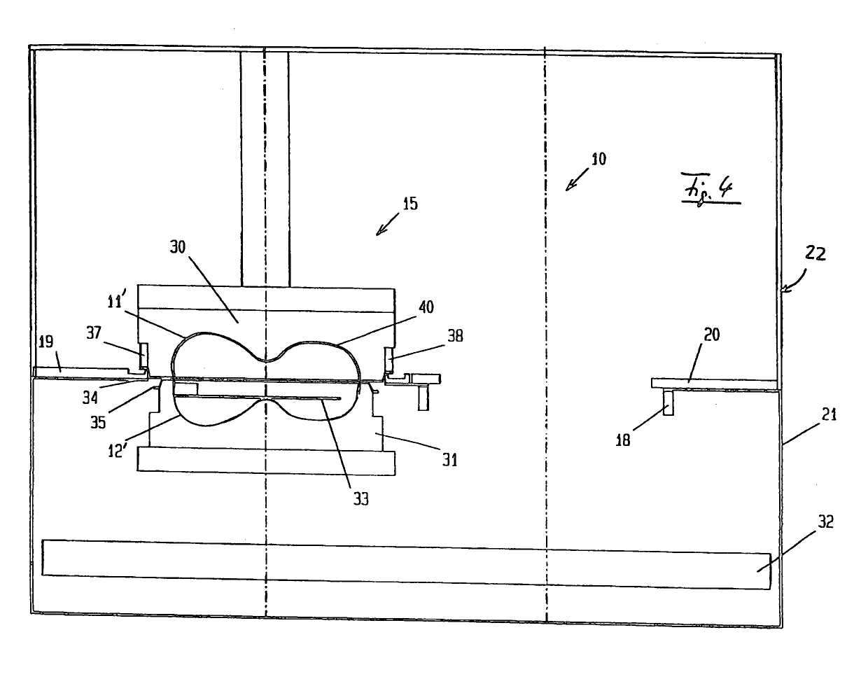

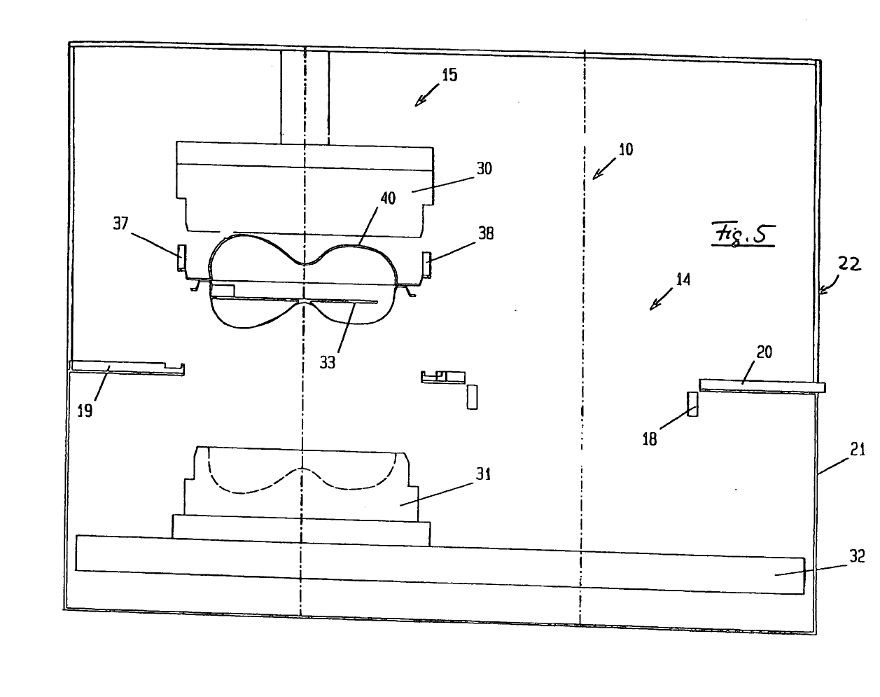

FIG. 4 shows a schematic representation of the device according to FIG. 1, wherein both formed parts are joined and bonded in the left forming station; FIG. 5 shows a schematic representation of the device according to FIG. 1 in a fabrication phase, in which the hollow body is lifted by grip elements for removing it from the lower tool and the lower tool is lowered;

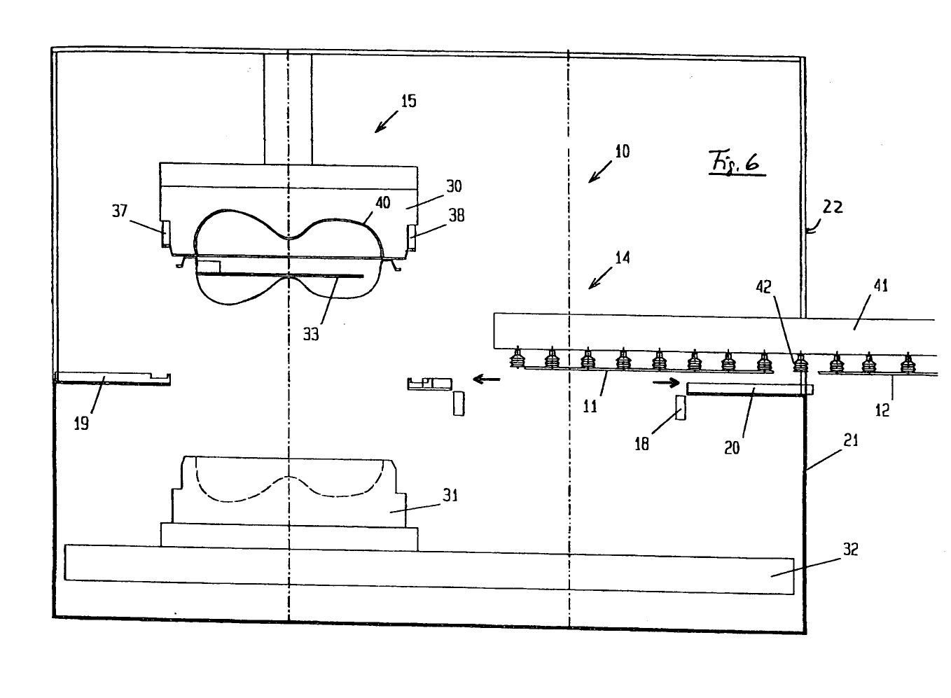

FIG. 6 shows a schematic representation of the device according to FIG. 1 in a phase, which immediately follows after the phase according to FIG. 5, wherein a charge carriage with two new thermoplastic blanks drives in; and

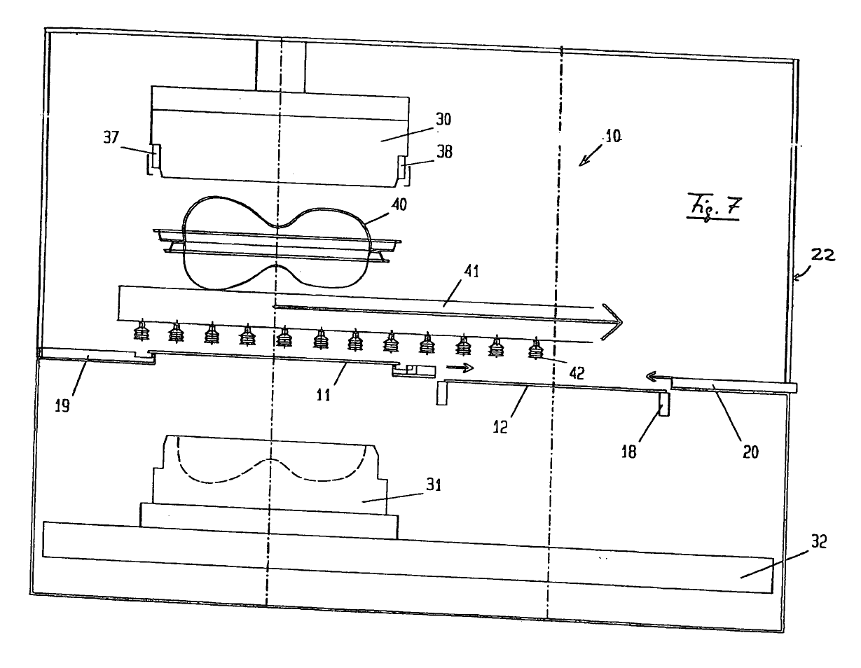

FIG. 7 shows a schematic representation of the device according to FIG. 1 in a phase following FIG. 6, in which the thermoplastic blanks are already deposited in the forming stations and the previously fabricated hollow body comprising an integrated insert has fallen down for being transported away after the grip elements on the upper side of the charge carriage were opened.

The figures schematically illustrate a device 10 for fabricating a hollow body containing at least one insert from two thermoplastic blanks 11, 12 by means of vacuum forming or thermoforming. In FIG. 1 the quadrangular thermoplastic blanks 11, 12 are each disposed in associated forming stations 15, 14, wherein they are each clamped at the sides of their edges between a clamping frame 17, 18 and a window plate system 19, 20 and sag, due to their inherent weight, downwardly in the direction of a closed housing 21. The housing 21 is closed, thus allowing the thermoplastic blanks, which become soft while being heated, to be supported in a controlled manner due to a small overpressure in the housing 21, so that an undesired sagging of the thermoplastic blanks is avoided and the passage can purposively be kept in a predefined area.

Each of the forming stations 14 and 15 comprises an upper heater 23, 25 for the upper side of the thermoplastic blanks 11, 12 and a lower heater 24, 26 for the lower side of the thermoplastic blanks, 11, 12. The upper heaters are provided with a temperature sensor 28, 29. Such a temperature sensor may also be provided at the lower heater 24, 26.

A form tool 30 for the fabrication of the upper formed half of the hollow body is illustrated in the left forming station 15 above the heater 23. For the fabrication of the lower half of the formed part of the hollow body a form tool 31 is provided inside the housing 21 in the right forming station 14. The lower form tool 31 is arranged on a shifting table 32 and, on said table, may be brought into a position underneath the heater 24 in the forming station 15, as will be explained later.

The device illustrated in the figures is surrounded by a closable machine housing 22 comprising at least one non-illustrated closable opening for feeding thermoplastic blanks and for withdrawing fabricated hollow bodies.

FIG. 2 shows a fabrication phase, in which the heaters 23 and 26 are preferably laterally moved out of the area of the form tools, and the form tool 30 rests on the clamping frame 17, and the form tool 31 is adjacent the clamping frame 18 from below. The thermoplastic blank 11 was formed to a formed part 11′ in the forming station 15, the edges of which are positioned between the clamping frame 17 and the window plate system 19. The thermoplastic blank 12 is formed into a lower formed part 12′ the surrounding edges of which are positioned between the clamping frame 18 and the window plate system 20. In the lower formed part 12′ an insert 33 is affixed in a non-illustrated manner by clamping, gluing or bonding.

FIG. 3 shows a subsequent phase of fabrication of the hollow body, wherein the upper formed part 11′ still is held at the sides of its edges between the clamping frame 17 and the window plate system 19 in the forming station 15. In the right forming station 14, however, the clamping frame 18 was moved in an outward direction at the side of the edge after having been lifted off the edge of the lower formed part 12 on the right side so as to release the formed part 12′. Together with the lower form tool 31 the same then has moved downwardly and, according to FIG. 3, is located on the shifting table 32 on its way to the forming station 15 for being positioned underneath the upper formed part 11′.

FIG. 4 shows another fabrication phase, in which the lower formed part 12′ and the upper formed part 11′ are pressed against each other and bonded at the sides of their edges, wherein—as can be seen—the surrounding edge 34 of the upper formed part 11′ is broader than the surrounding edge 35 of the lower formed part 12′.

In the phase shown in FIG. 4 the hollow body already cools down. The window plate system 19 is opened and allows the grip elements 37, 38 to grip the upper formed part 11′ from underneath a cranked-off section of the surrounding edge 34 thereof. The grip elements 37 and 38 are aligned over the circumference of the edge 34 in a distributed manner, wherein the number thereof is defined according to need. The heater 24 still shown in FIG. 3 was preferably laterally moved out of the area of the forming station 15 prior to the upward movement of the lower form tool 31. The grip elements 37 and 38 are coupled to the upper form tool 30 and, in the next fabrication phase and according to FIG. 5, move with the same in an upward direction away from the window plate system 19, while the lower form tool 31 has moved downwardly onto the movement table 32.

FIG. 6 differs from the representation according to FIG. 5 merely in that a charge carriage 41 is schematically illustrated, which feeds new thermoplastic blanks 11 and 12 into the forming stations 14 and 15 by means of suction cups 42 provided at the underside thereof. The window plate system 20 in the forming station 14 is opened, allowing the new thermoplastic blank 12 to fall onto the clamping frame 18, which is in the initial position as shown in FIG. 1. The window plate system 19 of the forming station 15 is in the closed working position according to FIG. 1, as to pick up the new thermoplastic blank 11 falling down from the charge carriage 41, as is shown in FIG. 7.

According to the fabrication method illustrated in FIG. 7 the thermoplastic blank 12 lies on clamping frame, and next the window plate system 20 is then moved into the working position shown in FIG. 1 to clamp the formed plate blank 12 at the side of its edges.

The lower form tool 31 still is positioned in the area of the left forming station 15 and then subsequently moves towards the right into the forming station 14, as is indicated in FIG. 1. The upper form tool 30 still is positioned above the charge carriage 41, wherein the grip elements 37 and 38 have meanwhile however released the surrounding edge 34 of the hollow body 40 and the hollow body 40 is disposed on the upper side of the charge carriage 41 for the withdrawal thereof. After laterally driving the charge carriage 41 out, without the previously fed new thermoplastic blanks 11 and 12 and with the fabricated hollow body 40 located on the same, the fabrication of the hollow body 40 is terminated and a new fabrication cycle with the new thermoplastic blanks 11 and 12 can be started, as was described in connection with FIG. 1 to FIG. 7.

1. Method for fabricating a hollow body containing at least one insert from two thermoplastic blanks by means of vacuum forming, thermoforming, or a combination thereof, comprising the following method steps:
feeding the thermoplastic blanks into a single closable machine housing and closing the machine housing;
separate simultaneous forming of the thermoplastic blanks to formed parts in the closed machine housing;
inserting and fixing at least one insert in one formed part in the closed machine housing;
joining the formed parts to obtain a pressing contact and bonding them in the closed machine housing; and
withdrawing the finished hollow body with the integrated insert upon opening the machine housing.

2. Method as claimed in claim 1, wherein the forming of the thermoplastic blanks is correspondingly performed in a forming station for an upper formed part and in a separate forming station for a lower formed part.

3. Method as claimed in claim 2, wherein for joining the formed parts, one formed part is released from the clamped position in its associated forming station and is moved together with a forming tool to the other formed part still located in its clamped position in its associated forming station.

4. Method as claimed in claim 2, wherein in each forming stations a double sided heating by means of heaters is performed prior to the forming.

5. Method as claimed in claim 4, wherein the heaters are moved from their working position into an inoperative position outside a forming tool area after the forming.

6. Method as claimed in claim 1, wherein the machine housing is open and the thermoplastic blanks are fed into the opened machine housing at the same time.

7. Method as claimed in claim 1, wherein the feeding of the thermoplastic blanks and the withdrawal of the finished hollow body are performed isochronously.

8. Method as claimed in claim 1, wherein each insert is fixed by clamping, gluing, bonding, or a combination thereof.

9. Device for fabricating a hollow body containing at least one insert from two thermoplastic blanks by means of vacuum forming, thermoforming, or a combination thereof, comprising.
a closable machine housing in which are arranged two forming stations with respective devices for moving a first and a second forming tool each forming tool being for clamping and heating a thermoplastic blank and for arranging and affixing the at least one insert in one formed part in a forming station are arranged,
wherein, when the machine housing is closed and the formed part with the insert affixed therein is located in the closed machine housing, the formed part with the insert affixed therein can be moved by a mover associated with the second forming tool to contact the other formed part and to bond it therewith.

10. Device as claimed in claim 9, wherein the thermoplastic blank has edges and each forming station comprises a clamping frame which can be moved away from all edges of the thermoplastic blank to release the formed part.

11. Device as claimed in claim 9, wherein each forming station comprises a continuously adjustable window plate system.

12. Device as claimed in claim 9, wherein the mover for the one formed part with the insert affixed therein is provided for a lowering and lifting in an area of a forming station appertaining to the formed part, for a lateral shifting to the other forming station and for the lifting and lowering in an area of the other forming station.

13. Device as claimed in claim 9 characterized in that wherein the first and the second forming tools are respectively the upper and the lower forming tools and wherein tool grip elements for removing the hollow body from the advanced lower forming tool in the other forming station are provided, which are movable under a clamping edge of the other formed part and which can be lifted together with the upper forming tool and moved apart for the withdrawal of the hollow body to release the same from the lower forming tool after opening the associated clamping frame.

14. Device as claimed in claim 9, wherein the machine housing comprises at least one closable opening for feeding thermoplastic blanks and for withdrawing fabricated hollow bodies.

15. Device as claimed in claim 9, wherein a charge carriage is provided for simultaneously feeding both thermoplastic blanks, and for withdrawing the hollow body.

16. Device as claimed in claim 9, wherein each thermoplastic blank has a surface and a lower side, and wherein each forming station comprises a respective heater for the respective surface of the respective thermoplastic blank and a respective heater for the respective lower side of the respective thermoplastic blank, wherein each heater can be moved from a working position into an inoperative position outside a forming tools area.

17. Device as claimed in claim 13, wherein the formed part, in which the at least one insert is arranged, has a comparatively smaller edge than the other formed part which is the upper formed part, so as to form a grip edge for grip elements.

18. Device as claimed in claim 11, wherein the continuously adjustable window plate system can be intermittently driven apart to arrange the thermoplastic blank on the clamping frame.

19. Device as claimed in claim 10, wherein each forming station comprises a continuously adjustable window plate system.

20. Device as claimed in claim 19, wherein the continuously adjustable window plate system can be intermittently driven apart to arrange the thermoplastic blank on the clamping frame.

21. Device as claimed in claim 15, wherein the charge carriage is provided for simultaneously feeding both thermoplastic blanks at the lower side thereof.

22. Device as claimed in claim 15, wherein the charge carriage is provided for withdrawing the hollow body at the upper side thereof.
